(19) United States
(12) Patent Application Publication
(10) Pub. No.: US 2010/0132114 A1
(43) Pub. Date: Jun. 3, 2010

(54) Portable hoist system for handicapped people

(76) Inventor: Leslaw Becker, Myslenice (PL)

Correspondence Address: LITMAN LAW OFFICES, LTD., POST OFFICE BOX 41200, SOUTH STATION, ARLINGTON, VA, 22204, US

(21) Appl. No.: 12/314,045

(22) Filed: Dec. 3, 2008

(51) Int. Cl. A61G 7/10

(52) U.S. Cl. 5/87.1; 5/81.1 R

(57) ABSTRACT

The portable hoist system for handicapped people includes a mobile carriage base; a fixed base; an elongated detachable mast extending vertically from and rotatably mounted to either of the bases; a lift arm pivotally mounted to a mast post; and a yoke operatively connected to the distal end of the lift arm. The mast includes a protruding socket adapted to be insertably mounted to a mast post mount on either of the bases, each mast post mount having a different configuration to accommodate the socket.

### BACKGROUND OF THE INVENTION

1. Field of the Invention

The present invention relates to lifting devices, and particularly to a portable hoist system for handicapped people to aid in transferring the handicapped individual from place to place, and which is capable of use in both vehicles and domiciles.

2. Description of the Related Art

Physically impaired or handicapped individuals who may not be able to move on their own power must rely on other individuals and/or mechanical apparatus to assist their movement. A hoist is a typical device employed to facilitate this process. One of the main functions of said hoist is to transfer the handicapped individual from one location to another, e.g. from a bed to a wheelchair. The hoist is usually mobile and includes a rotatable mast, a lifting arm and a yoke from which a sling type rig is attached to carry the individual. While the assistance from the hoist is greatly beneficial, the bulkiness of the device is ill suited for the individual to live as full a life style as possible because the individual is restricted to where the hoist is installed. In other words, the hoist is typically assembled in the home of the user where the utility thereof remains mostly confined within the walls of the domicile. If the user desires to travel abroad, the hoist would have to be disassembled, whole or in part, for ready transport. On the other hand, there is no guarantee that the hotel or residence at the travel destination would have a readily available hoist. The involved hassles act as a deterrent for the whole endeavor, and the individual would be more compelled to stay at home.

Thus, a portable hoist system for handicapped people solving the aforementioned problems is desired.

### SUMMARY OF THE INVENTION

The portable hoist system for handicapped people includes a mobile carriage base; a fixed base; an elongated detachable mast extending vertically from and rotatably mounted to either of the bases; a lift arm pivotally mounted to a mast post; and a yoke operatively connected to the distal end of the lift arm. The versatility of the portable hoist system for selective mounting on either of the bases allows the user more freedom of movement, especially for travel, so that the handicapped may use the hoist wherever needed.

These and other features of the present invention will become readily apparent upon further review of the following specification and drawings.

### BRIEF DESCRIPTION OF THE DRAWINGS

FIG. 1 is a perspective view of a portable hoist system for handicapped people according to the present invention.

FIG. 2 is a partially exploded perspective view of the portable hoist system of FIG. 1, showing mounting of the detachable mast to the movable base carriage.

FIG. 3 is a partially exploded perspective view of a portable hoist system for handicapped people according to the present invention, showing mounting of the detachable mast to a fixed base.

FIG. 4 is a front view of the embodiment of the portable hoist system of FIGS. 1 and 2.

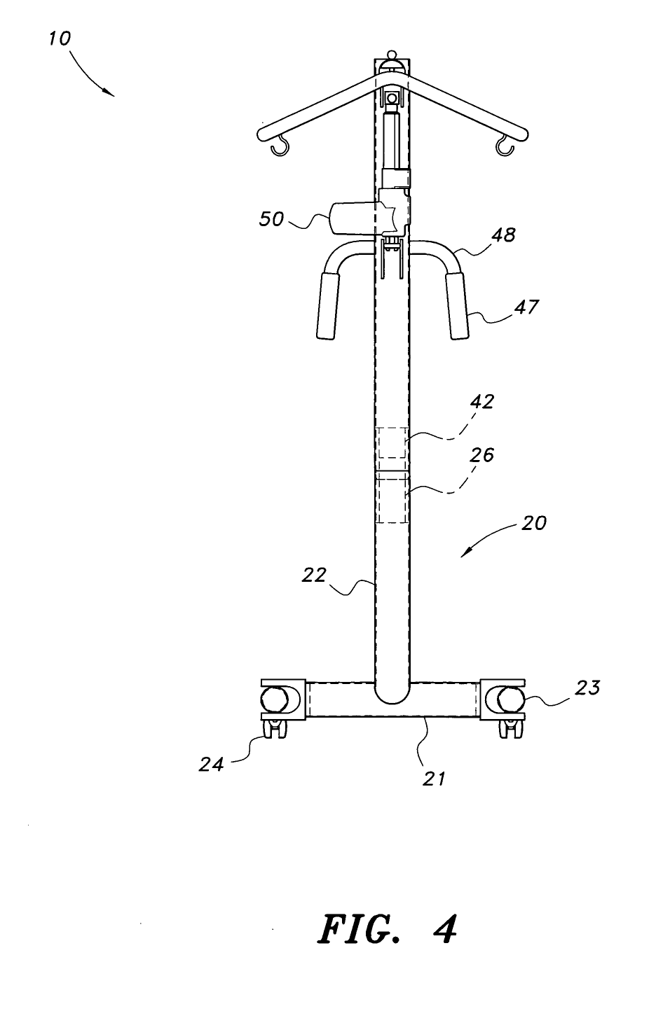

FIG. 5A is a side view of the portable hoist system of FIGS. 1, 2 and 4.

FIG. 5B is a partial, enlarged, exploded detail view of the portable hoist system of FIGS. 1, 2, 4, and 5A, showing the connection between the mast post and the mobile carriage base.

FIG. 6 is a top view of the portable hoist system of FIGS. 1, 2, and 4 through 5B.

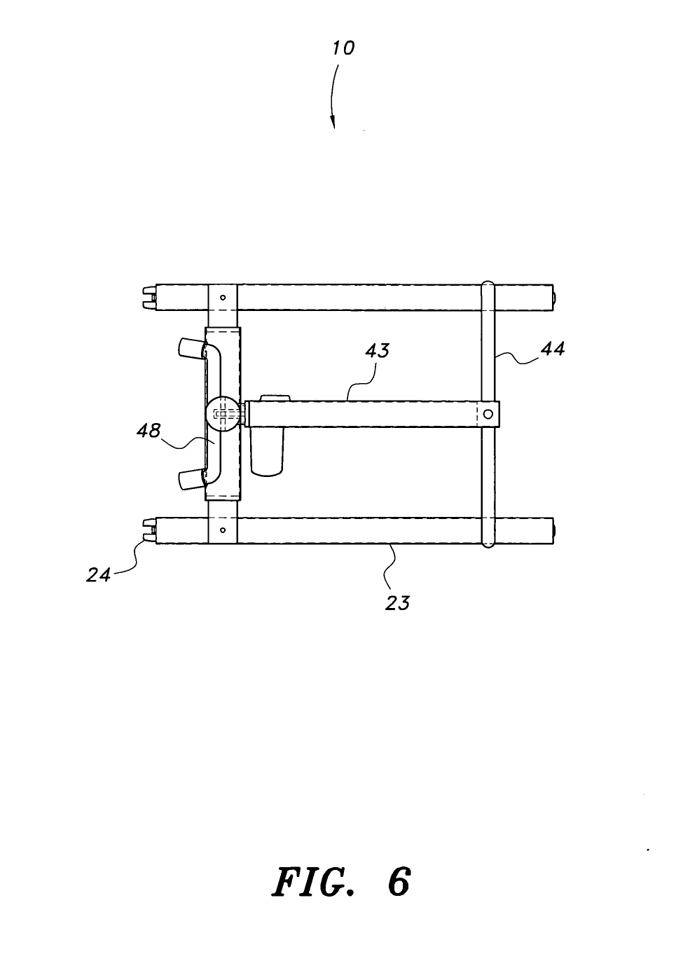

Similar reference characters denote corresponding features consistently throughout the attached drawings.

### DETAILED DESCRIPTION OF THE PREFERRED EMBODIMENTS

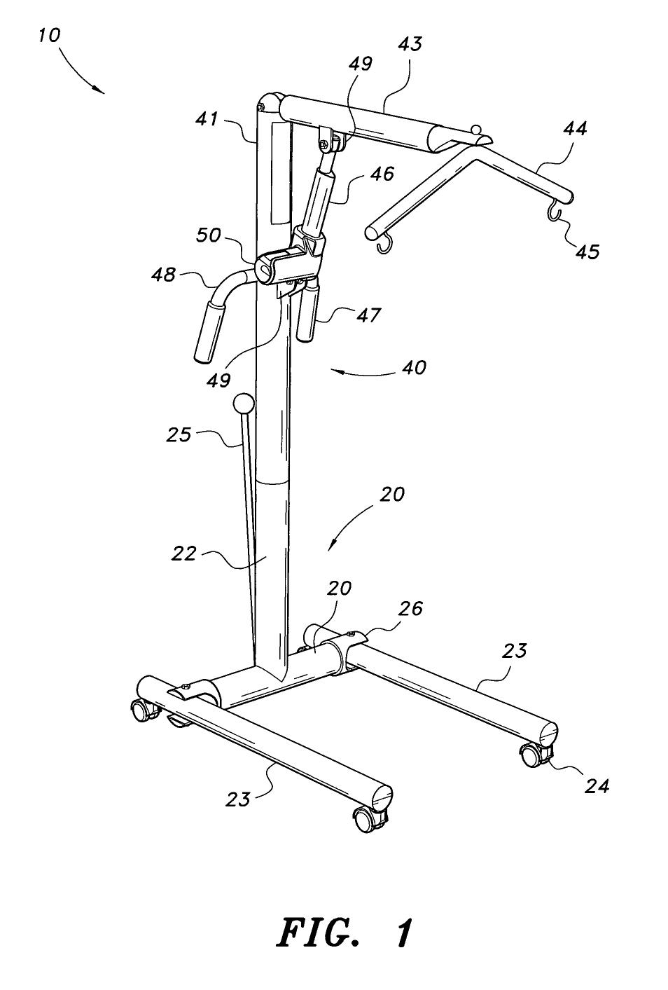

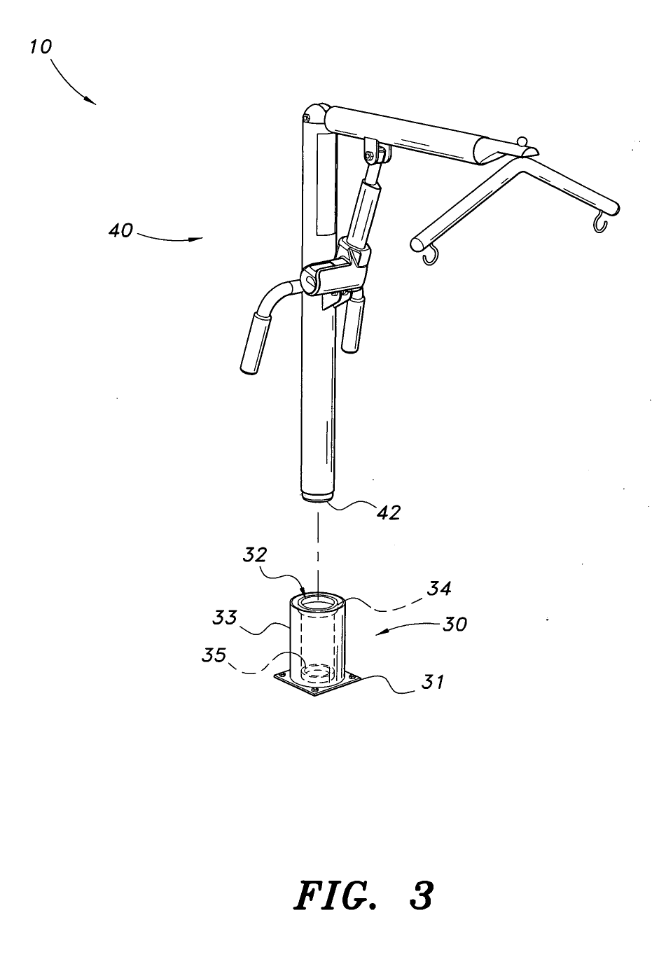

The present invention relates to a portable hoist system for handicapped persons, which allows them the services thereof anywhere without relying on a facility to provide one. As shown in FIGS. 1-3, the portable hoist system 10 includes a mobile carriage base 20, a fixed base 30, and a mast 40 rotatable about a vertical axis having a crane or lift arm 43 pivotally mounted to one end of a mast post 41. The mast 40 is adapted to be mounted on either the mobile carriage base 20 or the fixed base 30, the details of which will be further discussed below.

The mobile carriage base 20 includes a T-shaped pipe with a cross member 21 and an upwardly extending elongated mast post mount 22 defining the shape. Oppositely disposed notched holding jaws 26 are provided on the ends of cross member 21, and each jaw is adapted to clampingly hold mobility frame members 23 with respective fasteners. Each of the mobility frame members 23 may be a round bar having wheeled casters 24 disposed adjacent opposite ends of the bar. The mobility frame members 23 are arranged in parallel as facilitated by the respective operative connection to the cross member 21, which provides a sturdy base for movement of the portable hoist system 10. An elongated handle 25 projects from the mobile carriage base 20 for a user to grasp and maneuver the same.

The fixed base 30 includes a substantially flat square base mount plate 31 at the lower end which serves as a bracket to fixedly mount the base 30 at a predetermined location via fasteners. This location is usually the interior of a vehicle, but the fixed base 30 may be installed at any operative location where the user does not require mobility of the portable hoist apart from lifting and rotatable transfer of the handicapped individual. A cylindrical mast post mount 33 projects upwardly from the base mount plate 31 and includes a mounting bore 32 for rotatable mounting of mast post 41. The mounting bore -32 is fitted with two bearing assemblies, an upper bearing assembly 34 and a lower bearing assembly 35, the details of which will be further discussed below.

The mast 40 includes an elongated mast post 41 having a crane or lifting arm 43 pivotally mounted to one end of the mast post 41. A freely movable yoke 44 is operatively attached to the distal end of the lifting arm 43. Hooks 43 may be provided on the yoke 44 so that slings or other personal body support devices may be attached thereon. In addition, the mast post 41 may include a support bar 48 with handles 47 at the ends thereof for the user to carry or rotatably manipulate the mast 40, or as a general support for the handicapped person as he/she readies for transfer.

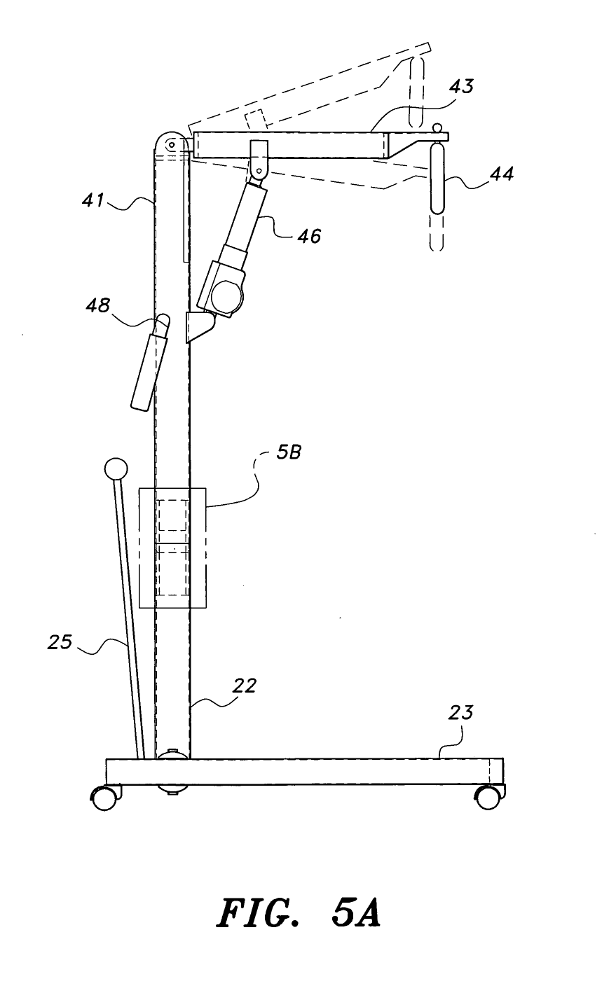

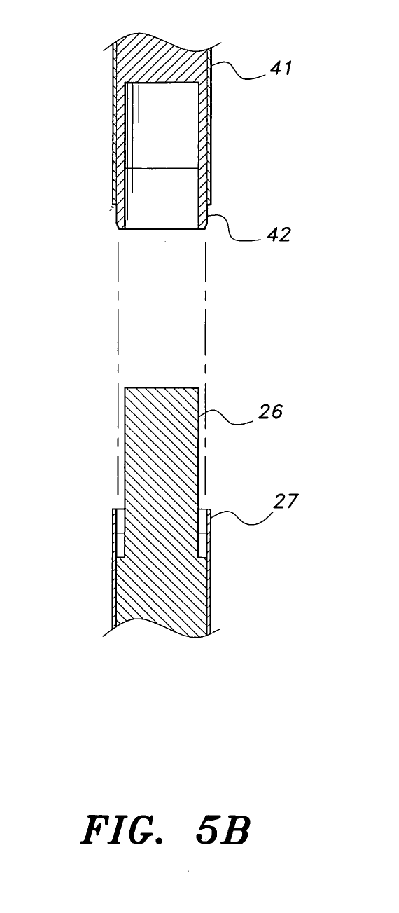

To operate the lift arm 43, a powered lifting assembly is provided between the mast post 41 and the lift arm 43. As shown in FIG. 5A, the lifting assembly includes a telescoping cylinder 46 with the ends thereof pivotally connected to respective pivots 49, 49 on the mast post 41 and the lift arm 43. A servomotor 50 controls extension and retraction of the telescoping cylinder 46.

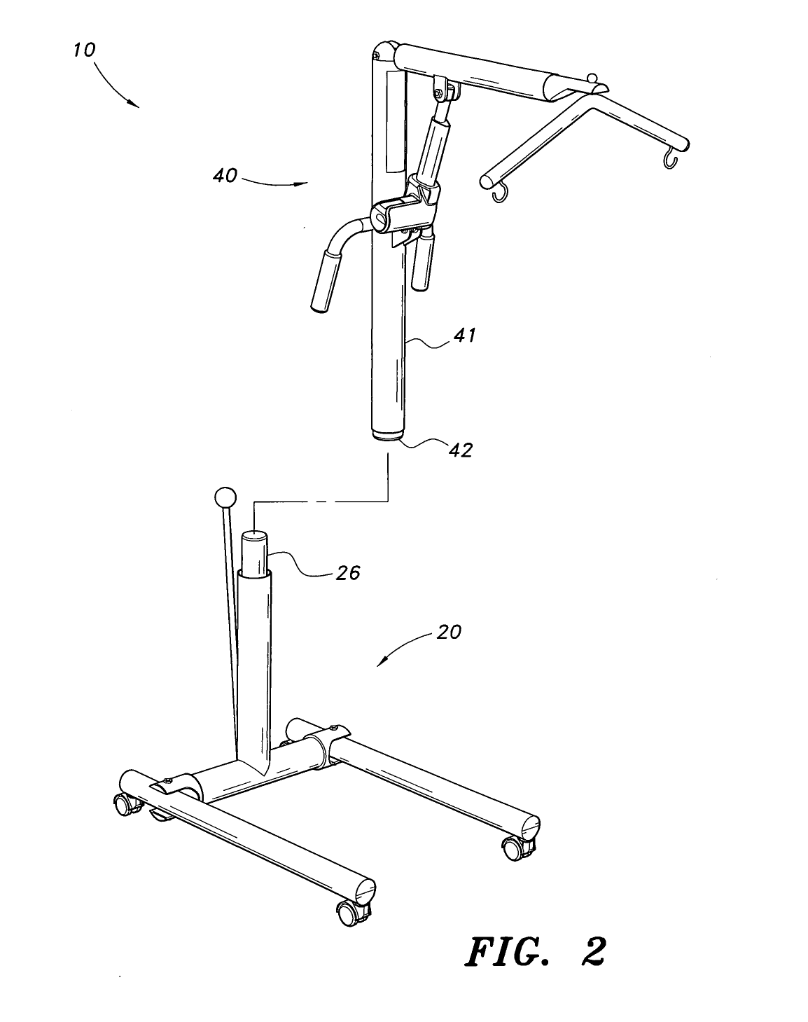

As shown in FIGS. 2 and 5B, the lower end of the mast post 41 includes a protruding socket 42 with an outer diameter smaller than the outer diameter of the mast post 41. The interior of the socket 42 includes a hollow cylindrical recess adapted for rotatable connection to the mobile carriage base 20, while the whole socket is adapted for connection to the fixed base 30.

Turning now to the respective base connections, to connect the mast 40 to the mobile carriage base 20, the upper end of mast post mount 22 is provided with a projecting spindle 26. As shown in FIG. 5B, the mast post mount 22 includes a partial annular recess which, in conjunction with the projecting spindle 26, forms a partial sleeve 27. The outer diameter of the spindle 26 corresponds to the inner diameter of the hollow cylindrical recess in the socket 42, and the inner diameter of the sleeve 27 corresponds to the outer diameter of the socket 42. Thus, when assembled, the spindle 26 fits into the cylindrical recess of socket 42 while the socket 42 concurrently fits into the sleeve 27, which combined forms a secure rotatable connection between the mast 40 and the mobile carriage base 20 without the use of additional parts, tools or fasteners.

To connect the mast 40 to the fixed base 30, the fixed base 30 is provide with an upper bearing assembly 34 at the top and a lower bearing assembly at the bottom of the mounting bore 32. The inner diameter of the upper bearing assembly 34 corresponds to the outer diameter of the mast post 41, and the inner diameter of the lower bearing assembly 35 corresponds to the outer diameter of the socket 42. Thus, when assembled, the mast post 41 and the socket 42 are securely and rotatably supported by the upper and lower bearing assemblies 34, 35 respectively without the use of additional parts, tools or fasteners for easy transfer of the handicapped individual. Each of the bearing assemblies may be ball or roller bearings.

The portable hoist system 10 may be used in two configurations, mobile and fixed. In the first or mobile configuration, as shown in FIG. 1, the user may maneuver the hoist 10 via the handle 25 to the desired location, e.g. bed or bathtub. Then the handicapped individual may lower the lift arm 43 via the servomotor 50 to strap into the sling (not shown), lift the lift arm 43, rotate the mast 40 about the vertical axis until the desired location is reached, and then lowered into the bed or bathtub.

In the second or fixed configuration, the portable hoist system 10 may function as, e.g., a car lifter. The fixed base 30 may be mounted in the interior of a vehicle or van. The mast 40 may be detached and rotatably installed into the fixed base 30 so that the user may be transferred from his/her current location to a vehicle seat, the lowering, lifting and transferring operations being substantially the same as above with the mobile configuration.

It is noted that the present invention may encompass a variety of alternatives to the various features thereof. For example, other shapes such as square or rectangular members may be used in place of the round or cylindrical members discussed above or shown in the drawings. The portable hoist system 10 may be made from sturdy lightweight materials so that it can be easily carried by the user while the fixed base 30 may be made from steel or any other robust material able to securely and reliably support the mast 40 therein.

It is to be understood that the present invention is not limited to the embodiments described above, but encompasses any and all embodiments within the scope of the following claims.

I claim:

1. A portable hoist system for handicapped people, comprising:
a mobile carriage base;
a fixed base; and
a mast alternately mountable to the mobile carriage base and the fixed base, the mast comprising;
an elongated mast post having a connection assembly at one end;
a lift arm pivotally mounted to the end of the mast post opposite the connection assembly, the lift arm having an end distal to the mast post;
a yoke disposed at the distal end of the lift arm; and
a lifting assembly disposed between the mast post and the lift arm, the lifting assembly being operable to raise and lower the lift arm;
wherein rotation of the mast transfers a handicapped person from a current location to another location.

2. The portable hoist system according to claim 1, further comprising an elongated handle projecting from said mobile carriage base.

3. The portable hoist system according to claim 1, further comprising an elongate support bar disposed on the mast post, the support bar having handles at opposite ends thereof.

4. The portable hoist system according to claim 1, wherein the connection assembly comprises a protruding socket having an outer diameter smaller than an outer diameter of the mast post, the socket defining a hollow cylindrical recess.

5. The portable hoist system for handicapped people according to claim 4, wherein the mobile carriage base comprises:
a T-shaped pipe having a cross member and an upwardly extending elongated mast post mount, the cross member having oppositely disposed notched holding jaws, and
a pair of mobility frame members clampingly engaged by the notched holding jaws, respectively, each of the mobility frame members having wheel assemblies operatively attached adjacent ends thereof.

6. The portable hoist system according to claim 5, wherein the mast post mount of the mobile carriage base comprises:
a spindle projecting from the upper end of mast post mount, and
a partial sleeve defined by an annular recess formed between the spindle and an outer diameter of the mast post mount;
wherein the spindle has an outer diameter corresponding to an inner diameter of the hollow cylindrical recess in the socket, and the sleeve has an inner diameter corresponding to the outer diameter of the socket, the spindle sliding into the socket and the socket sliding into the sleeve in order to securely and rotatably mount the mast post to the mobile carriage base.

7. The portable hoist system according to claim 4, wherein the fixed base further comprises:
a substantially flat, square base mount plate having mounting holes disposed thereon; and
a cylindrical mast post mount extending upwardly from the base mount plate, the mast post mount defining a mounting bore for rotatable mounting of the mast post therein.

8. The portable hoist system according to claim 7, wherein the mast post mount of the fixed base comprises an upper bearing assembly and a lower bearing assembly disposed within the mounting bore, the upper bearing assembly having an inner diameter corresponding to the outer diameter of the mast post, the lower bearing assembly having an inner diameter corresponding to the outer diameter of the socket to thereby securely and rotatably mount the mast post to the fixed base.

9. The portable hoist system according to claim 8, wherein said upper and lower bearing assemblies each comprise ball bearings.

10. The portable hoist system according to claim 8, wherein said upper and lower bearing assemblies each comprise roller bearings.

11. The portable hoist system according to claim 1, further comprising hooks operatively disposed on the yoke.

12. The portable hoist system according to claim 1, wherein the lifting assembly comprises:
a telescoping cylinder having one end pivotally connected to the mast post and an opposite end pivotally connected to the lift arm; and
a servomotor coupled to the telescoping cylinder for controlling extension and retraction of the telescoping cylinder.

13. A portable hoist system for handicapped people, comprising:
a mobile carriage base;
a mast mounted on the mobile carriage base, the mast comprising;
an elongated mast post having a connection assembly at one end;
a lift arm pivotally mounted to the end of the mast post opposite the connection assembly, the lift arm having an end distal to the connection assembly;
a yoke disposed at the distal end of the lift arm; and
a lifting assembly disposed between the mast post and the lift arm, the lifting assembly being operable to raise and lower the lift arm;
wherein rotation of the mast transfers a handicapped person from a current location to another location.

14. The portable hoist system according to claim 13, wherein the connection assembly comprises a protruding socket having an outer diameter smaller than an outer diameter of the mast post, the socket defining a hollow cylindrical recess.

15. The portable hoist system according to claim 14, wherein the mobile carriage base comprises:
a T-shaped pipe having a cross member and an upwardly extending elongated mast post mount, the cross member having oppositely disposed notched holding jaws, and
a pair of mobility frame members clampingly engaged by the notched holding jaws, respectively, each of the mobility frame members having wheel assemblies operatively attached adjacent ends thereof.

16. The portable hoist system according to claim 15, wherein the mast post mount of the mobile carriage base comprises:
a spindle projecting from the upper end of mast post mount, and a partial sleeve defined by an annular recess formed between the spindle and an outer diameter of the mast post mount;
wherein the spindle has an outer diameter corresponding to an inner diameter of the hollow cylindrical recess in the socket, and the sleeve has an inner diameter corresponding to the outer diameter of the socket, the spindle sliding into the socket and the socket sliding into the sleeve in order to securely and rotatably mount the mast post to the mobile carriage base.

17. A portable hoist system for handicapped people, comprising:
a fixed base; and
a mast alternately mountable to the mobile carriage base and the fixed base, the mast comprising;
an elongated mast post having a connection assembly at one end;
a lift arm pivotally mounted to the end of the mast post opposite the connection assembly, the lift arm having an end distal to the mast post;
a yoke disposed at the distal end of the lift arm; and
a lifting assembly disposed between the mast post and the lift arm, the lifting assembly being operable to raise and lower the lift arm;
wherein rotation of the mast transfers a handicapped person from a current location to another location.

18. The portable hoist system according to claim 17, wherein the fixed base comprises:
a substantially flat, square base mount plate having mounting holes disposed thereon; and
a cylindrical mast post mount extending upwardly from the base mount plate, the mast post mount defining a mounting bore for rotatable mounting of the mast post therein.

19. The portable hoist system according to claim 18, wherein the connection assembly comprises a protruding socket having an outer diameter smaller than an outer diameter of the mast post, the socket defining a hollow cylindrical recess.

20. The portable hoist system for handicapped people according to claim 19, wherein the mast post mount of the fixed base comprises an upper bearing assembly and a lower bearing assembly disposed within the mounting bore, the upper bearing assembly having an inner diameter corresponding to the outer diameter of the mast post, the lower bearing assembly having an inner diameter corresponding to the outer diameter of the socket to thereby securely and rotatably mount the mast post to the fixed base.
